(19) United States
(12) Patent Application Publication
(10) Pub. No.: US 2010/0027250 A1
(43) Pub. Date: Feb. 4, 2010

(54) BATTERY OPERATED LIGHTED CENTERPIECE

(75) Inventors: David W. Chen, Lewis Center, OH (US); Leighton L. Chen, Lewis Center, OH (US)

Correspondence Address: STANDLEY LAW GROUP LLP, 6300 Riverside Drive, Dublin, OH, 43017, US

(73) Assignee: Amerihua International Enterprises Inc., Lewis Center, OH (US)

(21) Appl. No.: 12/183,904

(22) Filed: Jul. 31, 2008

(51) Int. Cl. F21L 4/02; H05B 37/02

(52) U.S. Cl. 362/184; 315/362

(57) ABSTRACT

A centerpiece assembly comprising: (a) a base unit capable of supporting a plurality of illumination devices; and adapted to receive ornamentation; (b) at least one imitation candle; wherein the imitation candle includes a light source; a cavity; and a power supply; wherein the power supply is a replaceable battery; and wherein the power supply is adapted to be operationally coupled to an external electronic device via a DC socket; and (c) a support receptacle for each imitation candle; wherein the receptacle is attached to the base unit and is adapted to receive the artificial candle.

### CROSS REFERENCE TO RELATED APPLICATIONS

This non-provisional patent application makes no claim of priority to any earlier filings.

### TECHNICAL FIELD

This invention relates to decorative centerpieces, artificial lighting and candle holders. More particularly the present invention relates to a combination of artificial candles and a decorative centerpiece with additional lighting thereon.

### BACKGROUND AND SUMMARY OF THE INVENTION

Decorative centerpieces enhance the atmosphere of a room, and traditionally centerpieces have been a focal point of decoration for a meal or used as a way to dress up a table or fireplace mantle. During the holiday season, and to a lesser extent during the rest of the year, candles are popular accessories in decorative centerpieces. While aesthetically pleasing and highly popular, candles have significant drawbacks, namely maintaining the candle wick to prevent scorching and smoking, and the obvious dangers associated with having an open flame indoors.

In addition to employing candles in centerpieces consumers also use so-called holiday lights (viz. strands of small incandescent or the more modern strands of LED lights) in their centerpieces to provide additional light and enhance the appearance of the centerpiece. Much like the use of candles, the use of these lights produces the desired effect on the ambience of the room, however, they also suffer from a significant drawback; the fact that these light strands need electricity to operate. The need for electric power generally necessitates that these strands be plugged into a wall socket via a cord. The cord, while functional, detracts from the decorative effect of the centerpiece, and poses a tripping hazard while connected to the wall.

The broad purpose of the present invention is to provide a lighted decorative centerpiece that eliminates drawbacks associated with open flames and electrical cords. More particularly, it is an objective of the present invention to provide a centerpiece that incorporates imitation candle(s) and common strand lighting both of which are powered by a common source contained within the candle(s). It is further desired that the present invention contain a power source that is readily and easily replaced. This and other unmet advantages are provided by the system described and shown in more detail below.

In one embodiment the present invention includes a base unit adapted to provide a frame for displaying various types of themed ornamentation as well as providing a means for displaying candles either artificial or conventional. In some embodiments of the invention the length of the frame is between about 18 and 60 inches, with a plurality of cans for supporting and displaying candles. Although a plurality of cans for supporting multiple candles is preferred, the present invention includes configurations wherein a single candle is employed. Preferably, the unit also includes holiday themed ornamentation.

The base unit may be made from any of the well-known materials that frames for candle-holding centerpieces are manufactured from, including plastics, resins and metals. In a preferred embodiment, the base unit is made from powder-coated metal, and is colored in such a fashion that it does not detract from the themed ornamentation displayed thereon.

In one embodiment, the candles are artificial and are powered by a self contained power supply, much like the artificial candles described in U.S. Pat. No. 6,616,308, which is hereby incorporated by reference. However, while the imitation candle disclosed in U.S. Pat. No. 6,616,308 is designed to provide power solely to its own illumination source; the imitation candle claimed herein is adapted to provide power to external electronic devices. The power supply of the present invention is operationally coupled to a socket; the socket is situated with an opening in the exterior of the candle; and the socket is adapted to receive a power cord from an external extra-low voltage electronic device (e.g. a strand of electric lights). Although the candle described in U.S. Pat. No. 6,616,308 is an example of one suitable LED-based candle, other artificial LED-based illumination sources are within the scope of the present invention and may be used in conjunction with or without the candle described therein.

The term extra-low voltage device is used herein to refer to small consumer electronic devices, those that draw less than 120V of direct current. The term replaceable battery or battery are used throughout, these should not be construed to limit the scope of the present invention to any particular type of battery. The term is used merely for illustration, and it is intended that the present invention include any compact portable power source, whether primary (commonly called disposable) or secondary (rechargeable). The battery may be comprised of any of the many types of electrochemical cells, including galvanic cells, electrolytic cells, fuel cells, flow cells, or other types of after arising battery power supplies deemed safe for household use.

In an embodiment the imitation candle is adapted with a power socket. The power socket is operationally connected to the power supply for the artificial candle, such that the socket is in electrical communication with the socket. The power socket is selected from any number of power sockets appropriate for extra-low voltage electronic devices, including but not limited to sockets for cylindrical, snap and lock, or tip connectors. Accordingly, the electric lights included in the themed ornamentation are adapted, with an appropriate direct current (DC) connector or plug, to accept power from the power socket described above. Furthermore, the DC connector or plug, for the electric lights is selected such that it may be removably coupled with the socket in the artificial candle.

Those skilled in the art will recognize that many socket and connector combinations are appropriate for the present invention. The description of the particular socket and connector combinations above should not be construed to limit the present invention to the combinations described, rather, embodiments of the present invention may include any combination of socket and connector appropriate for extra-low voltage electronics.

The artificial candles also include a power switch which functions to turn the respective candle on and off. The aforementioned power switch also may be adapted to provide alternative settings wherein the lights are powered by the battery while the candle is off; where the candle is on and the lights remain plugged in but are not illuminated; and where both light sources are not illuminated. Additionally, the switch may have a setting relating to a timer function such that the centerpiece can be turned on for a predetermined period of time, for example four hours, before automatically shutting off.

In one embodiment, the holiday decoration includes electric lights and decorative artificial greenery. The electric lights may be the common type of strand lights including but not limited to incandescent, LED etc. used in holiday displays and the like. The strands are arranged about the artificial candles such that each artificial candle can provide power to the lights. In an embodiment, the artificial greenery includes several types of coniferous plant greenery (e.g. fir, pine etc.), an assortment of colored berries, pine cones, and optionally ribbons and/or holiday ornaments, all of which may be arranged randomly throughout the decoration.

The system may also include an optional “music box” for playing music from the centerpiece. The music box is adapted to be operationally coupled to the artificial candle in substantially the same fashion as the electric lights.

Optionally, the holiday themed decoration may be removable. The base unit is designed such that the centerpiece will be aesthetically pleasing with or without themed decoration. However, the centerpiece may also include other types of themed decoration (e.g. red, white and blue decoration for Independence Day), such that the centerpiece can remain seasonal and be employed throughout the year with a variety of optional accessories.

### BRIEF DESCRIPTION OF THE DRAWINGS

FIG. 1 is a top view of the base unit with the cans attached.

FIG. 2 is a side view of the same base unit as FIG. 1.

FIG. 3 is a perspective view of the base unit with an artificial candle situated in one of the cans.

FIG. 4 is a perspective view of an exemplary artificial candle.

FIG. 5A is a perspective view of an artificial candle adapted with a DC power socket, FIG. 5B is an embodiment of a cord for a strand of electric lights adapted with a cylinder-type DC power connector.

FIG. 6 is a circuit schematic for an embodiment of an artificial candle.

FIG. 7 is an alternative circuit schematic for an embodiment of the present invention.

FIG. 8 is a more detailed circuit schematic for an alternative embodiment of the present invention.

FIG. 9 is a color photograph of an embodiment of the present invention displaying themed decoration arranged around several artificial candles.

### DETAILED DESCRIPTION OF THE DRAWINGS

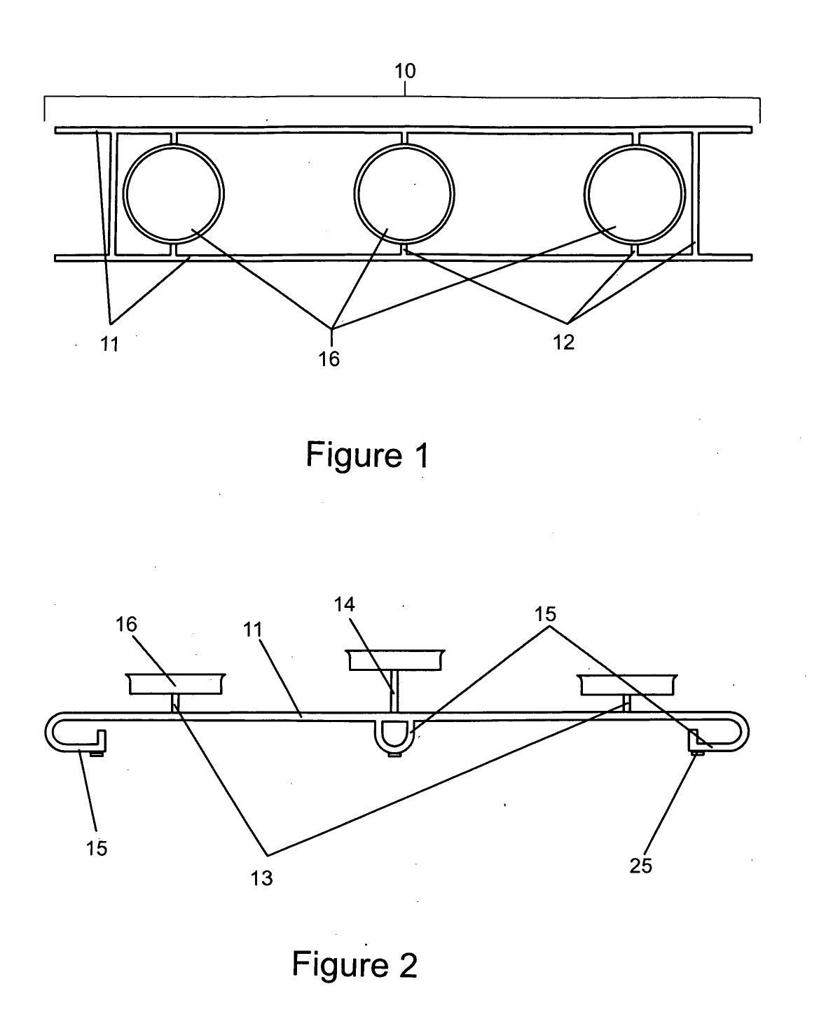

FIG. 1 is a top view of the base unit 10 of an exemplary assembly, with the artificial candles and decoration removed from the frame. The base unit includes at least two main support rods 11, and a plurality of horizontal support rods 12. The figure depicts three cans 16, for holding either artificial or alternatively traditional candles, while there are three cans depicted in the drawings, the drawings should not be construed to limit the scope of the invention, as embodiments of the present invention may include a greater or lesser number of cans than are shown in the drawings.

FIG. 2 is a side view of an arrangement similar to that in FIG. 1. From this view, additional elements become apparent, namely the vertical support rods 13 and 14, the support members 15, and the optional scratch preventing pads 25, attached to the underside of each support member 15. It is apparent that the cans 16, for holding the candles are supported by a vertical support rod 13 or 14, for each can. The vertical support rods rise from individual horizontal support rods 12.

The vertical support rods 13, and 14 are preferably positioned such that they are substantially vertical and perpendicular to whatever surface the unit is placed upon. While the vertical support rods are shown with the outside rods 13, substantially equal in height, both being shorter than the center support rod 14; it is not intended for the drawings to limit the present invention to that arrangement of heights. It is intended that embodiments of the present invention include any variety and combination of heights of the vertical support rods 13, and 14 that is consistent with the theme of providing an aesthetically pleasing centerpiece.

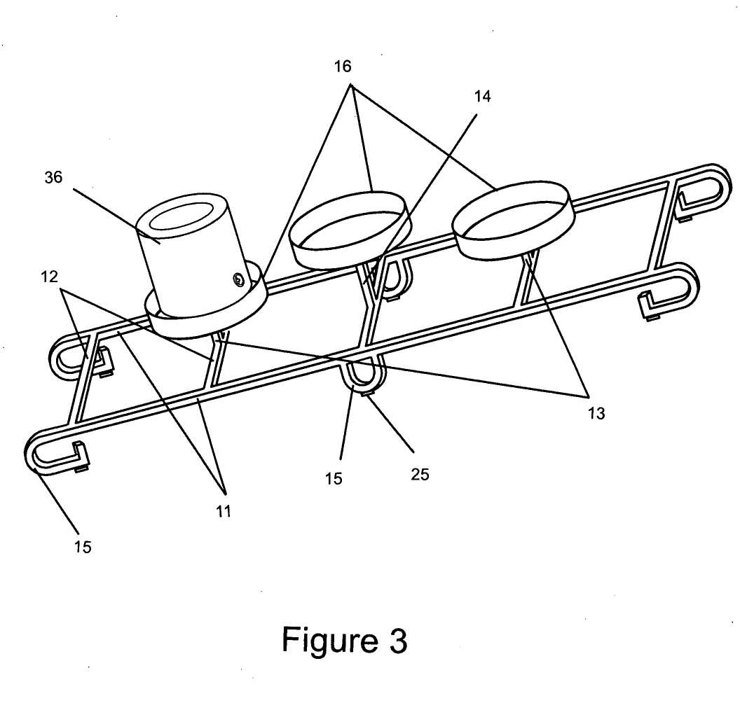

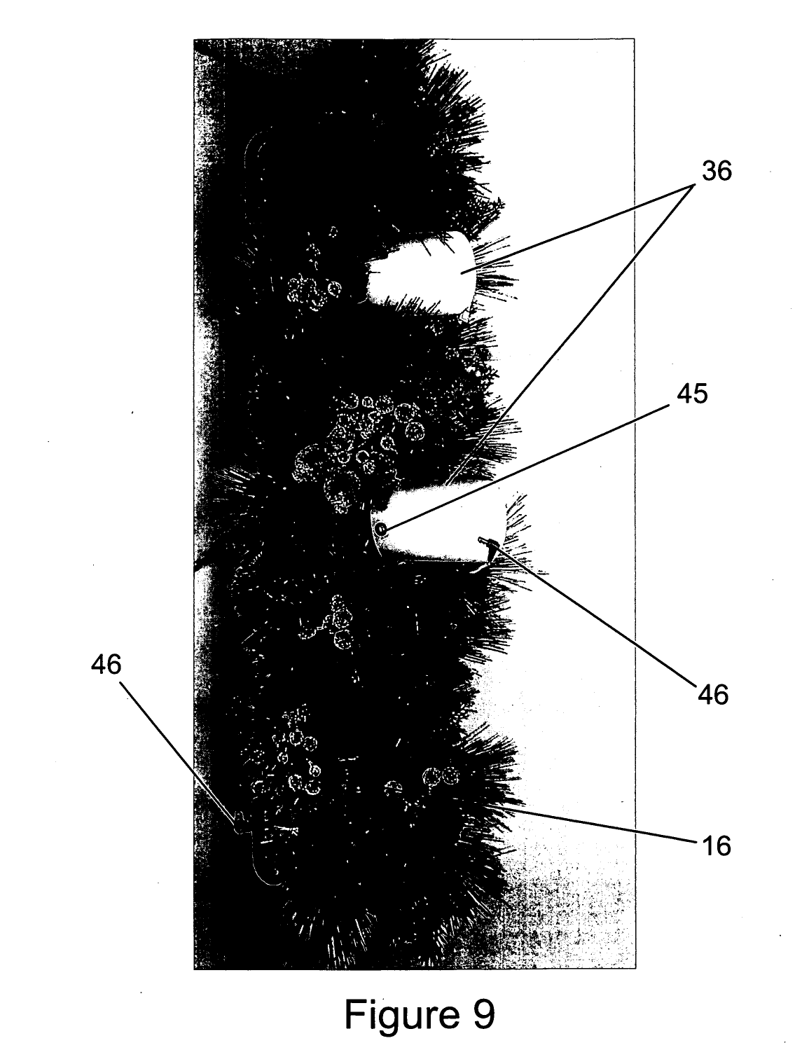

FIG. 3 is a perspective view of an embodiment of the present invention illustrating a representative base unit with an artificial candle placed in one of the cans. It is apparent from this illustration that the candles rise above the base. The themed ornamentation including the light strands is arranged about the base unit, substantially below the tops of the artificial candles. A potential arrangement of the themed ornamentation demonstrating the relative positions of the elements is illustrated in the color photograph, FIG. 9.

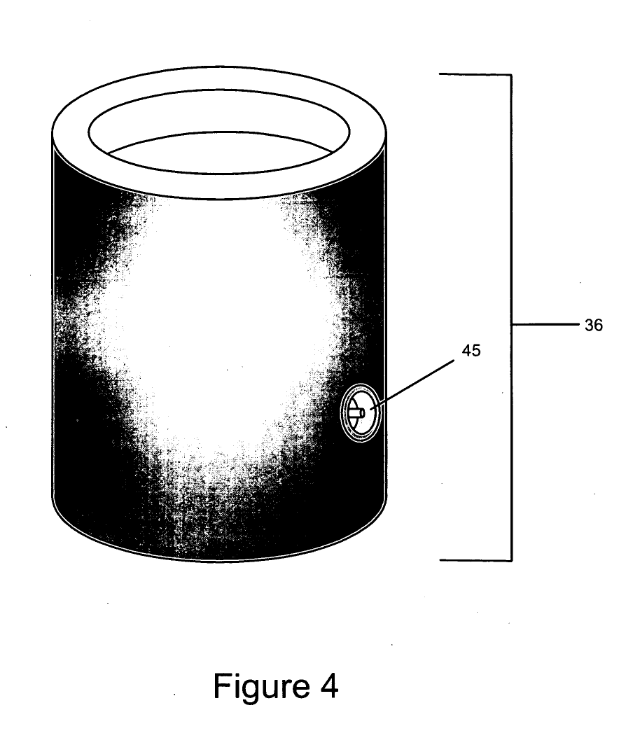

FIG. 4 is a perspective view of an exemplary artificial candle 36, adapted to provide power, via a DC-power socket 45, to an external electronic device such as a strand of electric lights. The socket depicted is mounted on the side of the candle. Because the socket 45, is small in relation to the overall size of the side of the candle, the present invention appears much the same as a conventional candle. Placement of the socket in the lower-half of the candle allows for operational connection of the external electronic device in such a way that the connection may be easily hidden from view by the themed ornamentation. Additionally, due to the placement of the socket and its relatively small size, the candle may be rotated such that the connection is hidden from the view of observers, making the centerpiece substantially as aesthetically pleasing as a conventional candle.

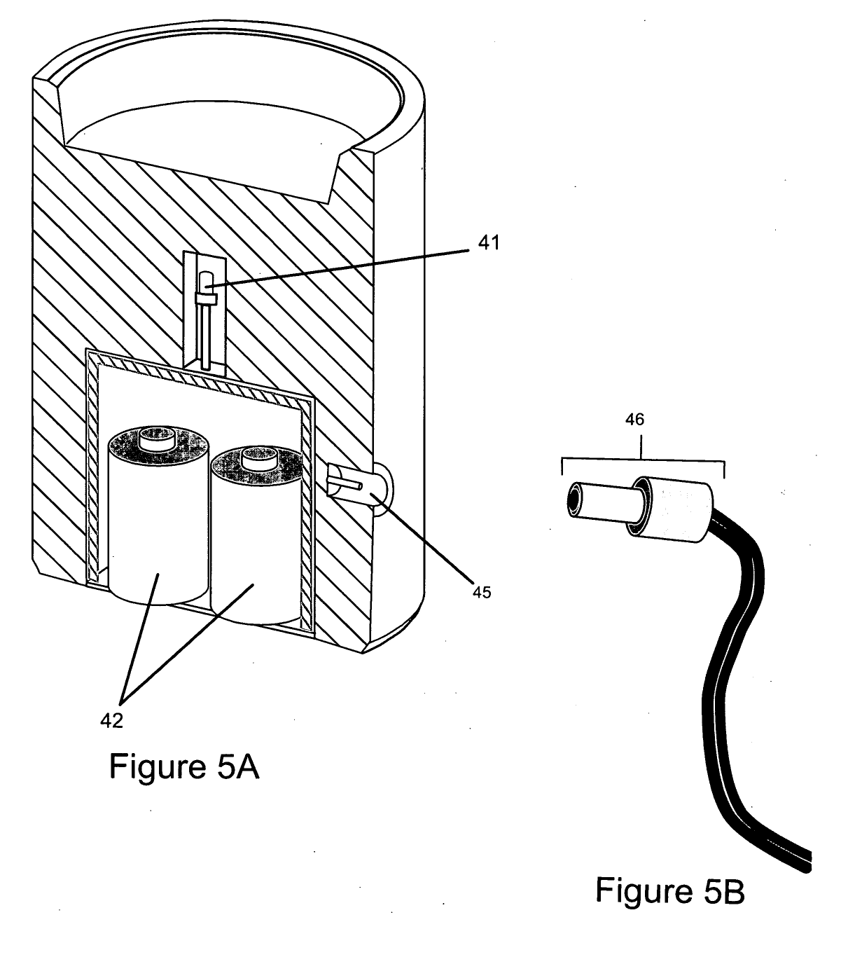

FIG. 5A, is a perspective cross section of an exemplary artificial candle 36, and FIG. 5B is an electrical connector for an external electronic device 46. From this view it is possible to discern many features of the invention, including the power socket 45, the illumination means 41, and the replaceable battery power supply 42, all of which are substantially contained within the artificial candle. The power socket 45, is operationally connected to the power supply for the artificial candle, such that the socket is in electrical communication with power supply. The power socket is selected from any number of power sockets appropriate for extra-low voltage electronic devices, including but not limited to sockets for cylindrical, snap and lock, or tip connectors. The illumination means is any of the common types of illumination sources such as, incandescent bulbs, LED and the like.

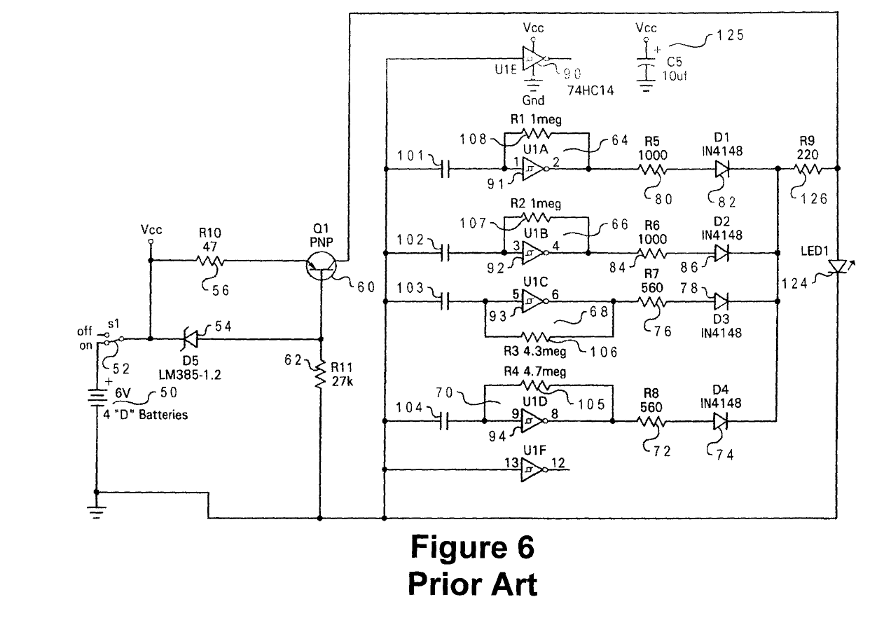

FIG. 6 is a circuit diagram of an embodiment of an imitation candle described in the prior art, namely U.S. Pat. No. 6,616,308. This diagram represents an embodiment of an imitation candle before adaptation to provide electricity to an external electronic device.

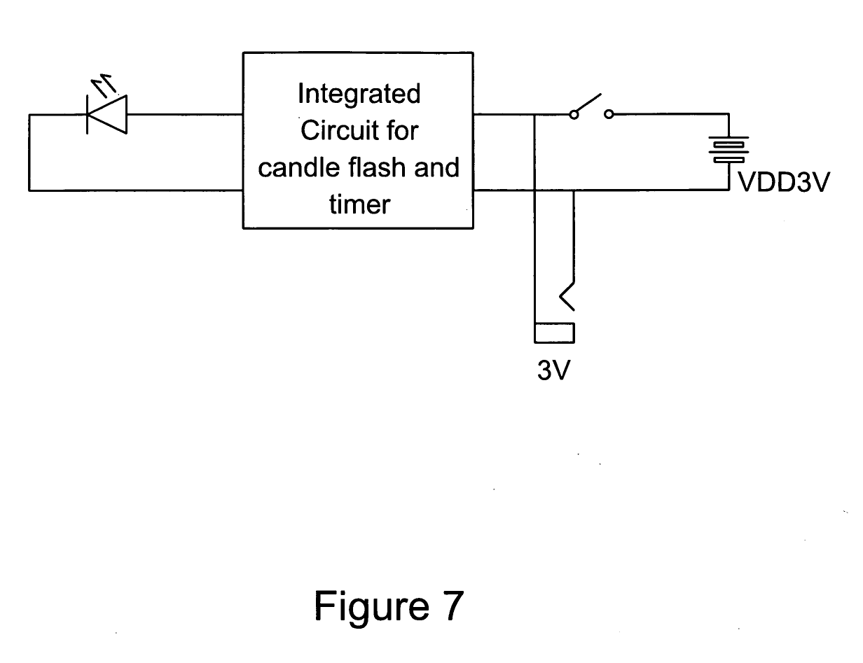

FIG. 7 is an embodiment of the circuitry of the present invention. It includes the illumination source, and LED; an integrated circuit to control the candle flash and timer; a switch; a power source; and the power socket. The switch in FIG. 7 may have a plurality of settings, including: ON, OFF and TIMER. At the “ON” switch position, both the candle and LED light string lights are illuminated. At the “OFF” switch position, both the candle and LED light string lights are not illumination. At the “TIMER” switch position, the LED candle is on for a predetermined period of time, while the LED light string lights are not illuminated.

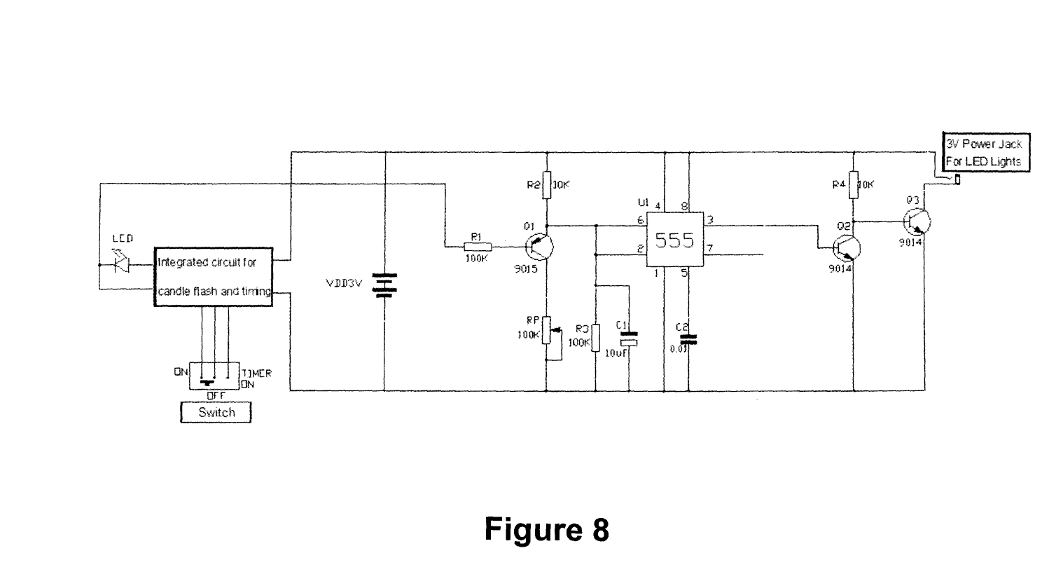

FIG. 8 is another embodiment of the present invention. FIG. 8 is a more detailed circuit diagram of an embodiment of the present invention. As shown in FIG. 8, the switch includes three settings: ON, OFF and TIMER. At the “ON” switch position, both the candle and the LED string lights are illuminated. At the “OFF” switch position, both the candle and the LED string lights are not illuminated. At the “TIMER” switch position, both the LED candle and the LED string lights are illuminated for a predetermined period of time prior to automatically turning themselves off.

The electric lights included in the themed ornamentation are adapted, with an appropriate DC connector or plug 46, to accept power from the power socket 45, described above. Furthermore, the DC connector 46, for the electric lights is selected such that it may be removably coupled with the socket 45, in the artificial candle.

Having shown and described embodiments of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

1. A centerpiece assembly comprising:
a base unit capable of supporting a plurality of illumination devices; and adapted to receive ornamentation;
At least one imitation candle; wherein said imitation candle includes a light source; a cavity; and a power supply; wherein said power supply is a replaceable battery; and wherein the power supply is adapted to be operationally coupled to an external electronic device via a DC socket; and
a support receptacle for each imitation candle; wherein said receptacle is attached to the base unit and is adapted to receive said artificial candle.

2. The centerpiece assembly of claim 1, wherein the assembly further includes themed ornamentation.

3. The centerpiece assembly of claim 2, wherein the themed ornamentation further includes a plurality of light sources which are adapted to receive power via the DC socket of the artificial candle.

4. The themed ornamentation of claim 3, wherein the plurality of light sources is a strand of electric lights.

5. The centerpiece assembly of claim 1, wherein the base unit is comprised of a powder coated metal.

6. The centerpiece assembly of claim 2, wherein the themed ornamentation is removable.

7. The centerpiece assembly of claim 1, wherein the base unit is a frame; the frame is adapted to receive the themed ornamentation; and includes at least one vertical support structure, said vertical support structure rising from the frame and adapted to maintain at least one support receptacle and an accompanying ornamental illumination device.

8. The centerpiece assembly of claim 7, wherein the base unit is comprised of powder coated metal.

9. The centerpiece assembly of claim 1, further comprising themed ornamentation; said ornamentation including at least one extra-low voltage electronic device; said extra-low voltage device including either a plurality of electric lights or a device for playing music; wherein the extra-low voltage device is adapted to be operationally coupled, via a DC connector, to a DC socket for a battery source.

10. The centerpiece assembly of claim 1, further comprising themed ornamentation; wherein the themed ornamentation is removable.

11. An imitation candle comprising:
a power supply; the power supply comprising a replaceable battery;
a light source;
a cavity within the candle, wherein the power supply is positioned within the cavity; wherein the imitation candle power supply is adapted to provide electric power to an external electronic device via a DC socket; and
a switch, wherein the switch is capable of powering the artificial candle alone, the external electronic device alone, or both the artificial candle and the external electronic device simultaneously.
